(19) United States
(12) Patent Application Publication
(10) Pub. No.: US 2025/0367953 A1
(43) Pub. Date: Dec. 4, 2025

(54) PRINTING APPARATUS

(71) Applicant: CANON KABUSHIKI KAISHA, Tokyo (JP)

(72) Inventors: YUKIMICHI KIMURA, Kanagawa (JP); YU INOUE, Kanagawa (JP); TOSHIYA MATSUMOTO, Kanagawa (JP); KYOHEI SATO, Kanagawa (JP); YASUHITO TSUBAKIMOTO, Tokyo (JP); KANETO TOKUYAMA, Tokyo (JP); KAZUTO ISHIHARA, Kanagawa (JP); TSUYOSHI SAEKI, Kanagawa (JP); RYOSUKE KOZONO, Kanagawa (JP); TAKAHIRO ITAMOTO, Kanagawa (JP)

(21) Appl. No.: 19/219,492

(22) Filed: May 27, 2025

(30) Foreign Application Priority Data
May 29, 2024 (JP) 2024-087247

(51) Int. Cl. B41J 29/02; B41J 2/17; B41J 3/44; B41J 29/13

(52) U.S. Cl. CPC B41J 29/02; B41J 2/1721; B41J 3/44; B41J 29/13

(57) ABSTRACT

Disclosed is a printing apparatus that includes a printing unit for performing printing on a sheet, a lower frame of a housing that accommodates the printing unit and forms at least a part of a conveyance path of the sheet, an upper frame supported by the lower frame as another part of the housing, and a unit mounted on the lower frame and supporting the upper frame together with the lower frame. The unit includes a positioning portion for positioning with respect to the lower frame. The positioning portion includes an engaging portion for engaging with the lower frame and being more downwardly elongated than an engaged portion of the lower frame engaged with the engaging portion.

### BACKGROUND

### Field of the Technology

The present disclosure relates to mainly a housing structure of a printing apparatus.

### Description of the Related Art

A printing apparatus, such as an ink jet printer or the like, is generally configured by mounting/assembling an element for implementing a printing function to a frame forming a housing (see Japanese Patent Laid-Open No. 2024-10888). Typical examples of the element include a power source, a power transmission mechanism, and a conveyance mechanism.

The weight of the above-described element that can be mounted to the frame of the printing apparatus is generally relatively large, which may cause distortion or the like in the frame and can also cause a decrease in printing accuracy by the printing apparatus. On the other hand, a technique for improving the robustness of the apparatus while coping with the complication of the apparatus structure accompanying recent multi-functionalization of the printing apparatus is sought after.

### SUMMARY

The present disclosure provides techniques advantageous for improvement of the robustness of a printing apparatus.

An aspect of the present disclosure provides a printing apparatus that includes a printing unit configured to perform printing on a sheet; a lower frame constituting a part of a housing configured to accommodate the printing unit, the lower frame forming at least a part of a conveyance path of the sheet and including an engaged portion; an upper frame constituting another part of the housing; and a unit configured to mount on the lower frame and support the upper frame. The unit includes a positioning portion for positioning with respect to the lower frame. The positioning portion includes an engaging portion for engaging with the lower frame. When engaged with the lower frame, at least a portion of the positioning portion extends lower than the engaged portion.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a printing apparatus according to an embodiment.

FIG. 2 is a perspective view illustrating an example of an internal structure of the printing apparatus.

FIG. 3A is a perspective views illustrating an example of a configuration of a frame.

FIG. 3B is an exploded perspective view of the frame of FIG. 3A.

FIG. 4 is a perspective view illustrating a back side of an example of the internal structure of the printing apparatus.

FIG. 5A1, FIG. 5A2, FIG. 5B1, FIG. 5B2, FIG. 5C1, and FIG. 5C2 are perspective views illustrating an example of mounting a waste liquid tank accommodating portion.

FIG. 6A, FIG. 6B, and FIG. 6C are simplified schematic diagrams of the mounting of the waste liquid tank accommodating portion.

FIG. 7 is a schematic diagram illustrating an example of a configuration of the printing apparatus.

FIG. 8 is a cross-sectional schematic diagram illustrating another side surface of the printing apparatus.

FIG. 9 is an enlarged view of a part of the printing apparatus.

FIG. 10A, FIG. 10B, and FIG. 10C are perspective views illustrating a structure of an upper frame.

FIG. 11 is an enlarged view of a part of the printing apparatus.

FIG. 12 is an enlarged perspective view of a part of the printing apparatus.

FIG. 13 is a perspective view illustrating an arrangement position of each element.

FIG. 14 is a schematic diagram illustrating the structure of the upper frame.

FIG. 15 provides left, top and right side views describing an arrangement aspect of elements included in the printing apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. In the drawings, the same reference numerals are given to the same or similar configurations, and redundant description thereof is omitted.

### First Embodiment

### <Overall Configuration of Printing Apparatus>

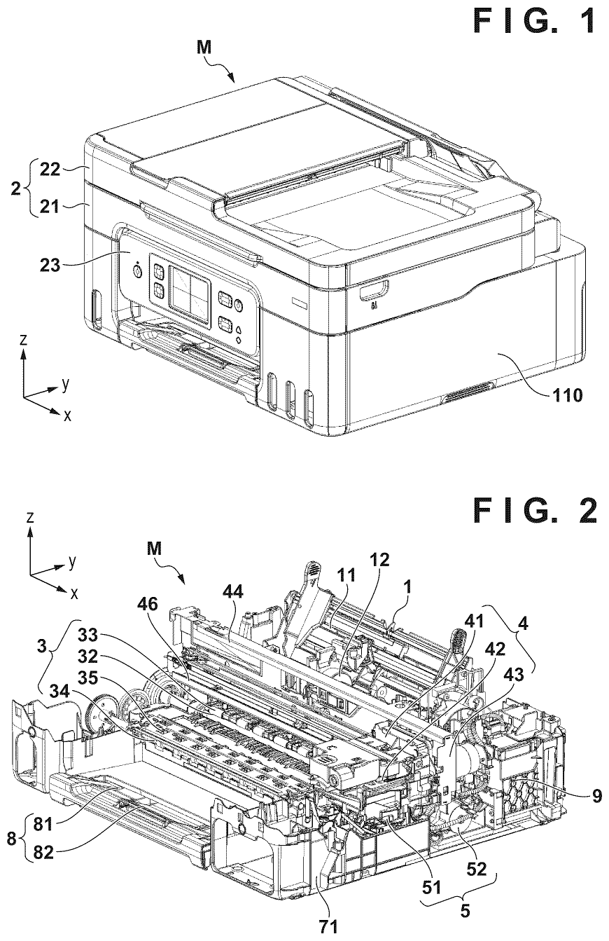

FIG. 1 is a perspective view illustrating an appearance of a printing apparatus M according to a first embodiment. FIG. 2 is a perspective view illustrating a part of the internal structure of the printing apparatus M. The printing apparatus M includes a feeding unit 1, an image reading unit 2, a conveyance unit 3, a printing unit 4, a maintenance unit 5, a frame 7, a paper ejection unit 8, and a waste liquid tank accommodating portion 9.

For ease of description of the structure, X, Y, and Z directions intersecting (substantially orthogonal to) one another are illustrated in the drawings. The X direction corresponds to the left-right direction or the width direction, the Y direction corresponds to the front-rear direction or the depth direction, and the Z direction corresponds to the up-down direction or the height direction.

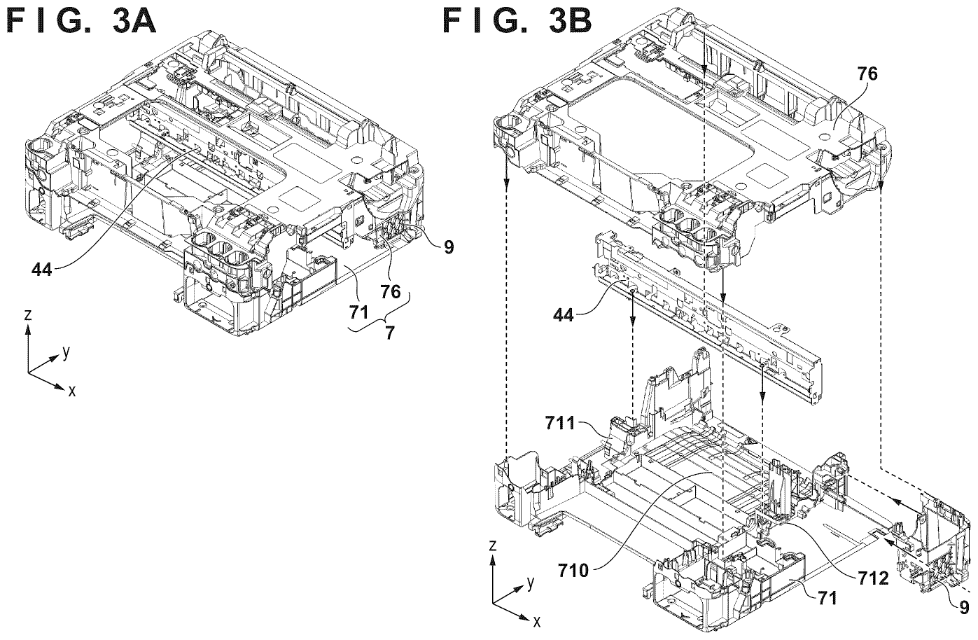

As further described herein, the frame 7 is formed by joining or connecting a lower frame (base material) 71 and an upper frame 76 to each other (see FIGS. 3A and 3B). An exterior cover 110 is mounted to the frame 7 from outside. A housing of the printing apparatus M is formed by the frame 7 and the exterior cover 110. Individual elements serving as movable units in printing operation of the printing apparatus M are supported to be rotatable or slidable mainly with respect to the frame 7.

The feeding unit 1 includes a pressing plate 11 and a feeding roller 12. A sheet (typically a paper material such as a cut sheet or other print medium) is placed on the feeding unit 1 and, in a case of two or more sheets, the two or more sheets can be stacked on the feeding unit 1. The sheet is taken into the housing (apparatus main body) one by one and supplied while being pressed against the pressing plate 11 by the feeding roller 12. The feeding unit 1 includes a stack tray, and the stack tray is rotatable with respect to the frame 7 so that it can be accommodated by being folded with respect to the housing when not in use.

The conveyance unit 3 includes a conveyance roller 32, a pinch roller 33, a paper ejection roller 34, and a pressing roller 35.

The conveyance roller 32 is a driving roller that rotates based on power from a power source such as an electric motor. The pinch roller 33 is a driven roller arranged to abut on the conveyance roller 32. The conveyance roller 32 conveys the supplied sheet toward the printing unit 4 described later while nipping the supplied sheet together with the pinch roller 33.

The paper ejection roller 34 is a driving roller that rotates based on power from the power source and conveys a sheet having been printed by the printing unit 4, and discharges the sheet to the paper ejection unit 8. The pressing roller 35 is a driven roller that regulates the printed sheet on the paper ejection roller 34 side, and a rolling surface thereof has an uneven shape so as to reduce a contact area with the sheet.

The paper ejection unit 8 includes a paper ejection tray 81 and a sub tray 82. The printed sheet discharged by the sheet discharge roller 34 is placed on the paper ejection tray 81. The sub tray 82 is an extension tray that can be pulled out from the paper ejection tray 81, and can be pulled out in accordance with the sheet size, for example.

The printing unit 4 includes a carriage 41, a print head 42, and a carriage motor 43. Additionally, the printing unit 4 further includes a chassis 44 and a rail 46, which need not be provided as a part of the printing unit 4.

The print head 42 has a configuration that can perform printing by an ink jet print method, and may perform printing onto a sheet by individually ejecting ink from a plurality of nozzles. The chassis 44 is a plate member fixed to the frame 7 and extending in the X direction, and the rail 46 is mounted to this chassis 44 (see FIG. 3B). The carriage 41 is equipped with the print head 42 and reciprocates in the X direction along the rail 46 based on the power of the carriage motor 43. The print head 42 scans in the X direction by reciprocation of the carriage 41, and performs printing during the scanning.

Printing refers to formation of an image on a sheet, and the image may include characters, numbers, symbols, figures, and photographs, as well as blanks that can be formed therebetween.

Printing on the sheet is executed by alternately performing intermittent conveyance in which the conveyance roller 32 (and additionally the paper ejection roller 34) conveys the sheet by a predetermined amount to suppress the conveyance and scan printing in which the print head 42 scans in the X direction to perform printing while the conveyance is suppressed. The print head 42 may also be a serial head.

As another embodiment, the print head 42 may be a line head elongating (extending) over the entire sheet width.

The maintenance unit 5 includes a suction cap 51 and a suction pump 52. The maintenance unit 5 is disposed at an end portion of a movable region of the print head 42. The suction cap 51 caps an ink ejection surface (nozzle surface in which a plurality of nozzles are arrayed) of the print head 42, and the suction pump 52 sucks air bubbles, thickened ink, and the like from each nozzle of the capped print head 42.

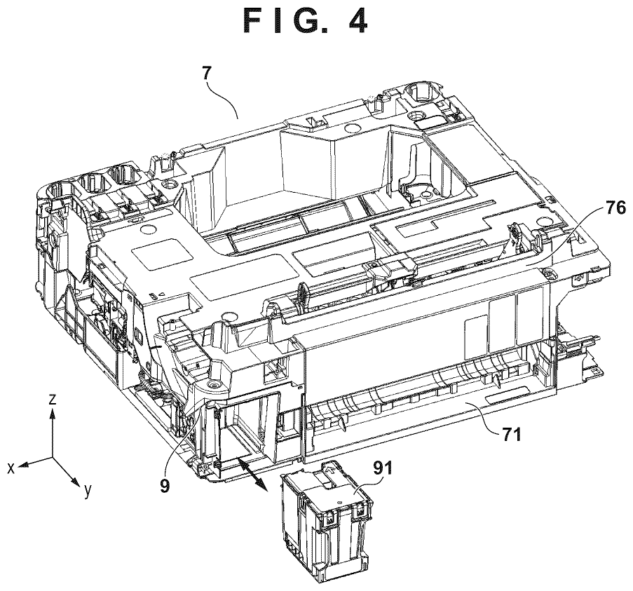

The sucked ink is output and reserved as a waste liquid (waste ink) into a waste liquid tank (waste liquid reservoir) 91 described herein and accommodated in the waste liquid tank accommodating portion 9 (see FIG. 4). The waste liquid tank accommodating portion 9 removably accommodates the waste liquid tank 91, and the waste liquid tank 91 is replaceable although details will be described later.

The image reading unit 2 includes a flatbed scanner (FBS) 21 and an auto document feeder (ADF) 22, and can implement an image reading function. For example, the FBS 21 and the ADF 22 can be mounted to the apparatus main body in a rotatable manner and axially supported on the upper frame 76 in a rotatable manner.

In such configuration, the FBS 21 can read an image from an image reading target (typically, a booklet) placed on the upper surface of the apparatus main body/nipped between the FBS 21 and the upper surface of the apparatus main body, and acquire image data thereof. The ADF 22 can sequentially capture the image reading target (typically, one or more documents) installed therein, and the FBS 21 can also perform image reading from the captured target.

In this manner, the printing apparatus M is a copier that has a printing function by the printing unit 4 as a main function and also has an image reading function by the image reading unit 2 as an auxiliary function. The auxiliary function may be omitted, or another auxiliary function such as a facsimile function may be added.

An operation panel 23 is installed on the front portion of the housing of the printing apparatus M. A touch panel display can be typically used as the operation panel 23. This enables the operation panel 23 to receive an operation input of a user, and can display or notify the user of information necessary for execution of the above-described printing or image reading.

FIGS. 3A and 3B are perspective views for describing the configuration of the frame 7. FIG. 3A illustrates a state in which the lower frame 71 and the upper frame 76 are joined to each other, and FIG. 3B illustrates a state in which they are disassembled.

As illustrated in FIG. 3B, the lower frame 71 forms at least a part of a conveyance path 710 of the sheet on the upper surface thereof. The lower frame 71 forms a wall portion 711 on one lateral direction side of the conveyance path 710 and forms a wall portion 712 on the other lateral direction side of the conveyance path 710. The above-described chassis 44 can be positioned by the wall portions 711 and 712, and can be fixed to the wall portions 711 and 712, for example, by fastening. Such a lower frame 71 can be integrally molded with resin.

The waste liquid tank accommodating portion 9 may be formed as a unit separate from the lower frame 71 and the upper frame 76, and is mounted from an opposite side to the conveyance path 710 with respect to the wall portion 712, with details described herein. In the present embodiment, the housing of the printing apparatus M has a quadrangular shape in top view, and the waste liquid tank accommodating portion 9 is positioned at one corner of four corners of the housing.

As indicated by the dashed line in FIG. 3B, the lower frame 71 and the upper frame 76 are joined to each other with the upper frame 76 being supported by the lower frame 71, with the waste liquid tank accommodating portion 9 disposed between the frames 71 and 76. The chassis 44 is disposed between the frames 71 and 76 in a state of being mounted with the rail 46, and is fixed to the lower frame 71. Additionally, the chassis 44 may engage with the upper frame 76.

FIG. 4 is a perspective view illustrating the back side of the internal structure of the printing apparatus M. As illustrated in FIG. 4, the waste liquid tank accommodating portion 9 can replaceably accommodate the waste liquid tank 91. The waste liquid tank 91 reserves, as waste ink/waste liquid, the ink sucked by the maintenance unit 5. For example, when the amount of waste liquid reserved in the waste liquid tank 91 reaches a reference amount, a predetermined display or notification can be output onto the operation panel 23. In response to this, the user can remove the waste liquid tank 91 by pulling it out from the waste liquid tank accommodating portion 9. The user can then mount a new/another waste liquid tank 91 by inserting it into the waste liquid tank accommodating portion 9.

The waste liquid tank accommodating portion 9 may be framed to form a space for accommodating the waste liquid tank 91, and may be referred to as an accommodating portion.

### <Arrangement Layout of Elements Included in Printing Apparatus>

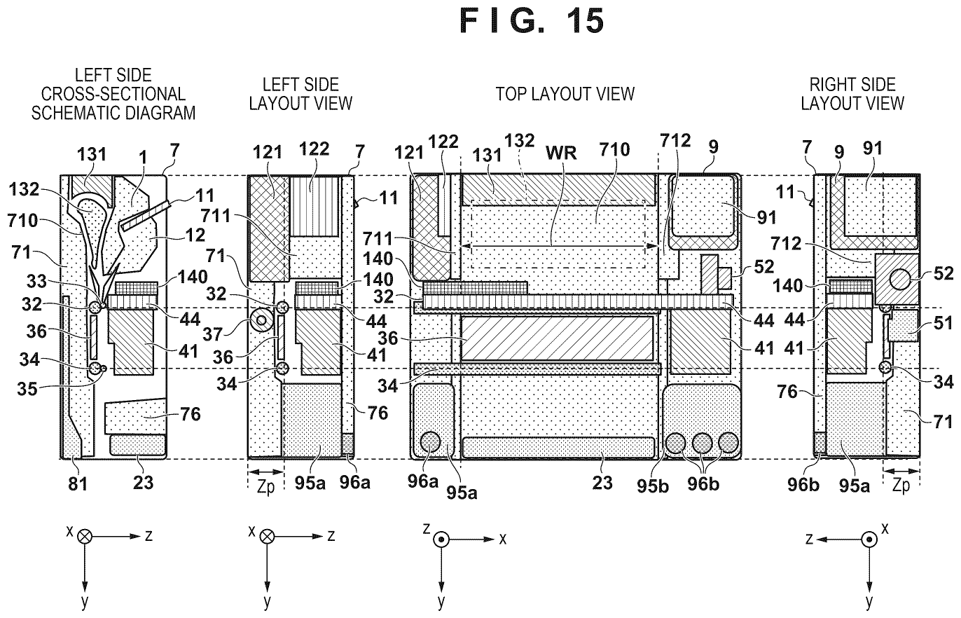

FIG. 15 is a schematic diagram (layout diagram in the housing) describing an arrangement aspect of the above-described individual elements included in the printing apparatus M. FIG. 15 includes a top layout view, a left side layout view, a right side layout view, and a left side cross-sectional schematic diagram corresponding to the left side layout view of the printing apparatus M.

FIG. 15 illustrates supply ink tanks 95a and 95b and supply ink tank plugs 96a and 96b. In the present embodiment, the printing apparatus M can execute color printing using a plurality of types of ink, and the supply ink tank 95a and the supply ink tank plug 96a can correspond to, for example, black ink. The supply ink tank 95b and the supply ink tank plug 96b correspond to other color ink such as yellow, magenta, and cyan.

FIG. 15 also illustrates a power source unit 121, a network control unit (NCU) 122, a conveyance guide 131, and an inner guide 132. The power source unit 121 generates power for supplying each element based on an external power source. The NCU 122 performs communication control with the outside.

The conveyance guide 131 guides conveyance of the sheet. The inner guide 132 includes the conveyance roller 32, and assists the guide of the conveyance guide 131 by rotation of the conveyance roller 32, whereby the sheet is conveyed toward a platen 36. In the present embodiment, as illustrated in the left side cross-sectional schematic diagram of FIG. 15, the sheet passes through the conveyance path 710 from the platen 36 and is conveyed again toward the platen 36 by the conveyance guide 131. In the present embodiment, the platen 36 is fixed at a substantially the same height Zp as the conveyance path 710, but may be fixed at a different height.

FIG. 15 also illustrates a main board 140. The main board 140 is equipped with a plurality of semiconductor components for performing arithmetic processing for performing drive control of the printing apparatus M. Examples thereof include a central processing unit (CPU), a random access memory (RAM), and a read only memory (ROM).

As seen from the top layout view of FIG. 15, the waste liquid tank accommodating portion 9 is positioned at one corner of the four corners of the housing, and, in the present embodiment, positioned on the side of the housing opposite to the power source unit 121 and the NCU 122, with the conveyance guide 131 and the inner guide 132 are arranged therebetween. That is, the waste liquid tank accommodating portion 9 is positioned on one lateral direction of the conveyance guide 131 and the inner guide 132, and the power source unit 121 and the NCU 122 are positioned on the other lateral direction.

In the present embodiment, the waste liquid tank accommodating portion 9 is wider than the power source unit 121 and the NCU 122. The supply ink tank 95b is wider than the supply ink tank 95a. Therefore, the waste liquid tank accommodating portion 9, the power source unit 121, the NCU 122, and the supply ink tanks 95a and 95b may be arranged in consideration of their widths.

Therefore, in the present embodiment, the power source unit 121 and the NCU 122 are arranged so as to overlap the supply ink tank 95a in the Y direction. The waste liquid tank accommodating portion 9 is disposed so as to overlap the supply ink tank 95b.

According to such an arrangement, a region WR for conveying the sheet may be secured at the center part.

### <Mounting of the Waste Liquid Tank Accommodating Portion>

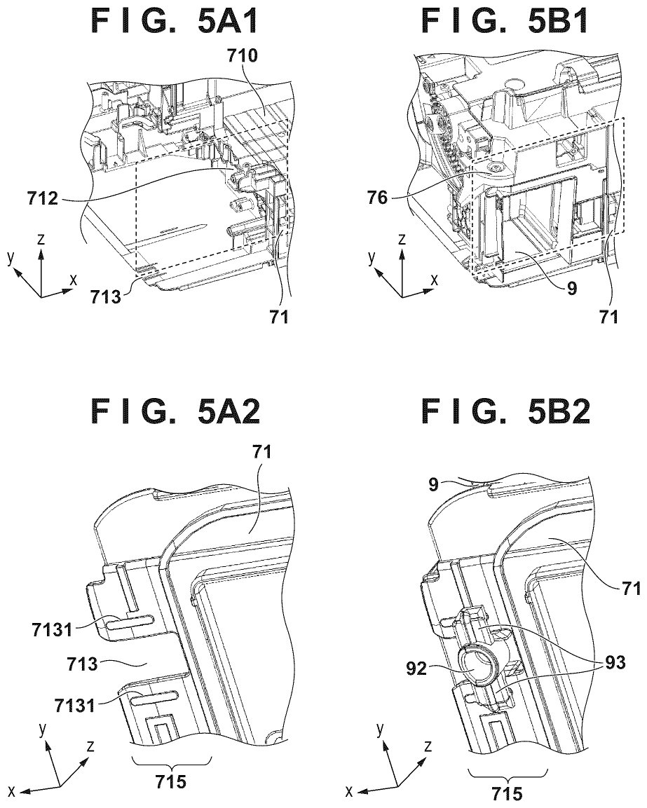

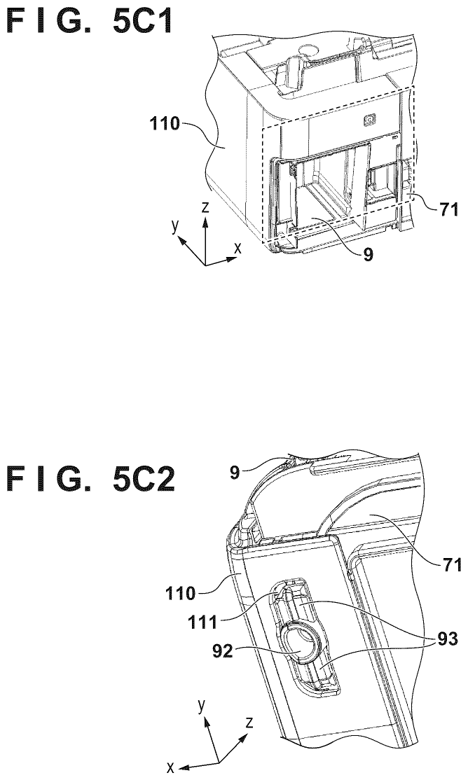

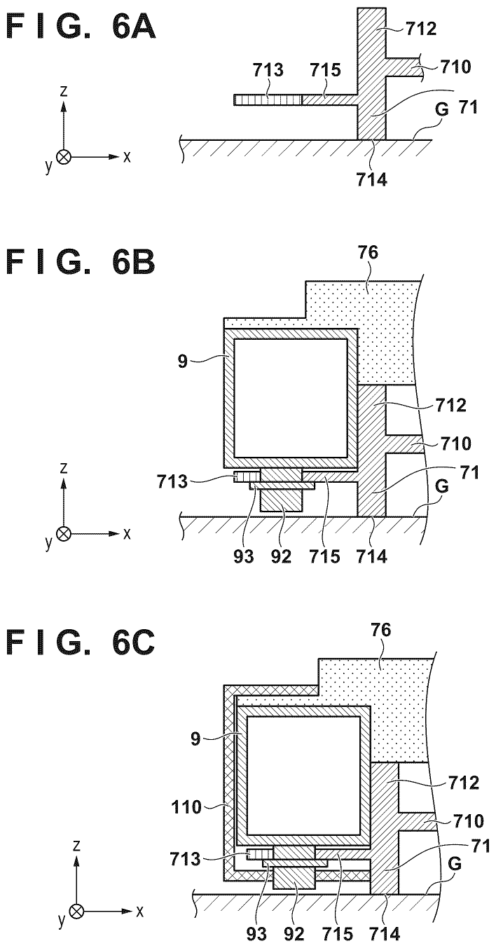

FIGS. 5A1 to 5C2 are perspective views illustrating mounting of the waste liquid tank accommodating portion. FIGS. 6A to 6C are schematic diagrams for describing a simplified mounting of the waste liquid tank accommodating portion 9.

FIG. 5A1 illustrates the back side of the lower frame 71 before being mounted with the upper frame 76, the waste liquid tank accommodating portion 9, and the exterior cover 110. FIG. 5A2 is a view from the bottom surface side of the back side of the lower frame 71, corresponding to FIG. 5A1. FIG. 6A corresponds to the state of prior to being mounted, as illustrated in FIGS. 5A1 and 5A2.

FIG. 5B1 illustrates the back side of the lower frame 71 after being mounted with the upper frame 76 and the waste liquid tank accommodating portion 9 and before being mounted with the exterior cover 110. FIG. 5B2 is a view from the bottom surface side of the back side of the lower frame, corresponding to FIG. 5B1. FIG. 6B corresponds to the state of mounting illustrated in FIGS. 5B1 and 5B2.

FIG. 5C1 illustrates the back side of the lower frame 71 after being mounted with the upper frame 76, the waste liquid tank accommodating portion 9, and the exterior cover 110. FIG. 5C2 is a view from the bottom surface side of the back side of the lower frame, corresponding to FIG. 5C1. FIG. 6C corresponds to the state of mounting illustrated in FIGS. 5C1 and 5C2.

As illustrated in FIG. 5A2, the lower frame 71 includes a cutout portion 713 extending in the X direction. Both lateral directions of the cutout portion 713 are provided with slotted hole surfaces 7131 extending in the X direction and are recessed.

As illustrated in FIG. 5B2, the waste liquid tank accommodating portion 9 includes a positioning portion 92 for positioning with respect to the lower frame 71. As illustrated in FIG. 6B, the positioning portion 92 elongates in a substantially column shape downward from the waste liquid tank accommodating portion 9 main body. In the present embodiment, the positioning portion 92 having the column shape is configured as a positioning boss that can fix the waste liquid tank accommodating portion 9 with respect to the lower frame 71 by fastening at the wall portion 712. As another embodiment, in addition to/in place of fastening at the wall portion 712, fastening at the positioning portion 92 may be performed.

As illustrated in FIGS. 5B2 and 6B, the positioning portion 92 includes an engaging portion 93 engageable with the lower frame 71. Here, a part of the lower frame 71 to be engaged by the engaging portion 93 is an engaged portion 715. In a state where the waste liquid tank accommodating portion 9 is mounted to the lower frame 71, the engaging portion 93 elongates along the lower surface of the engaged portion 715, thereby nipping the engaged portion 715 together with the waste liquid tank accommodating portion 9 main body. In this state, the engaging portion 93 is configured such that, for example, an end portion or an edge portion abuts the slotted hole surfaces 7131 in the Z direction and is locked.

As illustrated in FIG. 6B, the positioning portion 92 having the column shape is more elongated further downward than (beneath) the engaged portion 715. Mounting of the waste liquid tank accommodating portion 9 is implemented by inserting, while sliding, this positioning portion 92 into the cutout portion 713. That is, the cutout portion 713 allows the waste liquid tank accommodating portion 9 to be mounted from the lateral direction with respect to the lower frame 71. As illustrated in FIG. 5A2, since the cutout portion 713 is formed in the engaged portion 715, the engaged portion 715 may be expressed as including the cutout portion 713.

The mounting of the waste liquid tank accommodating portion 9 is completed by locking the engaging portion 93 to the slotted hole surfaces 7131 in a state where the waste liquid tank accommodating portion 9 main body abuts the wall portion 712.

When the upper frame 76 is mounted, as illustrated in FIG. 6B, the waste liquid tank accommodating portion 9 supports the upper frame 76 together with the lower frame 71. As mentioned above, the waste liquid tank accommodating portion 9 is mounted at an appropriate position with respect to the lower frame 71 by the positioning portion 92. Since the positioning portion 92 elongates in a substantially column shape downward from the waste liquid tank accommodating portion 9 main body, the user can easily grip the positioning portion 92 and can easily visually recognize the position thereof when mounting the waste liquid tank accommodating portion 9. Thus, according to the present embodiment, in the present structure in which the waste liquid tank accommodating portion 9 is disposed between the frames 71 and 76, support of the upper frame 76 is achieved by the lower frame 71 with the waste liquid tank accommodating portion 9, at an appropriate position. Accordingly, a support means that could have been provided in the lower frame 71 for supporting the upper frame 76 can be omitted and the structure of the lower frame 71 can be simplified.

Therefore, according to the present embodiment, a load of the upper frame 76 may be transmitted to the lower frame 71 while maintaining the strength of the lower frame 71, and robustness of the printing apparatus M may be improved. According to the present embodiment, since stress that could have been generated in the lower frame 71 is suppressed, the printing accuracy of the printing apparatus M can also be improved.

The positioning portion 92 may elongate to a ground contact surface 714 of the lower frame 71. In this case, the loads of the upper frame 76 and the waste liquid tank accommodating portion 9 can be transmitted to a placement surface G of the printing apparatus M by the positioning portion 92.

Thereafter, as illustrated in FIGS. 5C2 and 6C, the exterior cover 110 is mounted. The exterior cover 110 is opened in a lower portion, and a part thereof is illustrated as an opening portion 111 (FIG. 5C2). When the exterior cover 110 is then mounted, the exterior cover 110 covers the frames 71 and 76, which are joined to each other, and exposes the positioning portion 92 by the opening portion 111.

According to such configuration, the positioning portion 92 can be used when the exterior cover 110 is mounted to the lower frame 71, and also for positioning of the exterior cover 110. A connector or connection means that otherwise could have been necessary for the connection between the lower frame 71 and the exterior cover 110 can thus be omitted therefrom and the structures can be simplified. Also, after the exterior cover 110 is mounted, the positioning portion 92 can be visually recognized through the opening portion 111, and the position thereof can be regulated through the opening portion 111.

### SUMMARY

According to the present embodiment, the waste liquid tank accommodating portion 9 functions as a support assisting portion for supporting the upper frame 76, together with the lower frame 71. The positioning portion 92 for positioning the waste liquid tank accommodating portion 9 with respect to the lower frame 71 engages with the engaged portion 715 of the lower frame 71 by the engaging portion 93. The engaging portion 93 elongates along the lower surface of the engaged portion 715. The positioning portion 92 elongates more downward than at least a portion of the engaged portion 715, thereby easing positioning by gripping and visually recognizing.

According to such a structure, assistance in supporting the upper frame 76 at an appropriate position is obtained using the waste liquid tank accommodating portion 9 mounted to the lower frame 71. Accordingly, the support means that could have been provided in the lower frame 71 for supporting the upper frame 76 can be omitted, the structure of the lower frame 71 can be simplified, and robustness of the printing apparatus M can be improved. According to such a structure, the stress that could have been generated in the lower frame 71 is suppressed, and printing accuracy of the printing apparatus M is improved.

In the present embodiment in which the housing of the printing apparatus M has a quadrangular shape in top view, the waste liquid tank accommodating portion 9 is positioned at one corner of the four corners of the housing where a load can be generally large, whereby the waste liquid tank accommodating portion 9 can function more appropriately as a support assisting portion.

In the present embodiment, the engaged portion 715 of the lower frame 71 includes the cutout portion 713 formed so that the waste liquid tank accommodating portion 9 can be mounted from the lateral direction. The waste liquid tank accommodating portion 9 can be mounted from an opposite side to the conveyance path 710 with respect to the wall portion 712, and the cutout portion 713 can implement the mounting of the waste liquid tank accommodating portion 9 by sliding. The waste liquid tank accommodating portion 9 mounted to the lower frame 71 is fixed to the lower frame 71 by fastening at the positioning portion 92.

In the present embodiment, the waste liquid tank accommodating portion 9 is exemplified as the support assisting portion assisting the support of the upper frame 76, but the function may be implemented by another unit constituting a part of the printing apparatus M. That is, a unit included in the printing apparatus M may also function as the support assisting portion, and the robustness of the printing apparatus M can be improved.

### Second Embodiment

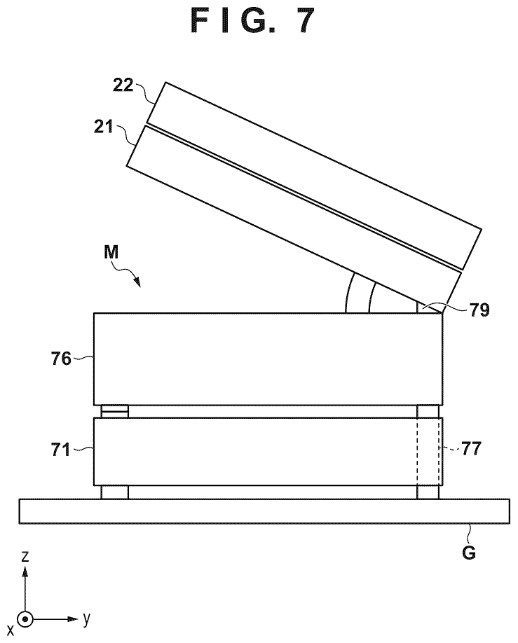

FIG. 7 is a schematic diagram illustrating a configuration example of the printing apparatus M according to a second embodiment. In the present embodiment, the printing apparatus M further includes a hinge 79 axially supporting the FBS 21 and the ADF 22, and a support column 77 extending in the Z direction below the hinge 79.

As mentioned above, the FBS 21 and the ADF 22 can be mounted rotatably to the apparatus main body. Therefore, in a state in which the FBS 21 and the ADF 22 are opened (i.e., with the FBS 21 and the ADF 22 rotated away from the apparatus main body), the loads of the FBS 21 and the ADF 22 are concentrated at a portion axially supporting the FBS 21 and the ADF 22.

Therefore, in the present embodiment, the hinge 79 is installed on the upper frame 76, and the support column 77 is positioned so as to overlap the position in the Z direction. That is, the support column 77 may be positioned below the part where the FBS 21 and the ADF 22 are axially supported. This support column 77 is independent of the lower frame 71, and may elongate downward without being connected to the lower frame 71, for example. As an example, the support column 77 is inserted through the lower frame 71 as indicated by the dashed line in FIG. 7.

According to such configuration, the support column 77 can appropriately transmit, to the placement surface G of the printing apparatus M, a load that can concentrate on the hinge 79 in a state where the FBS 21 and the ADF 22 are opened, and at that time, the upper frame 76 and the lower frame 71 are not applied with unnecessary stress.

### <<Another Aspect of Structure of Printing Apparatus>>

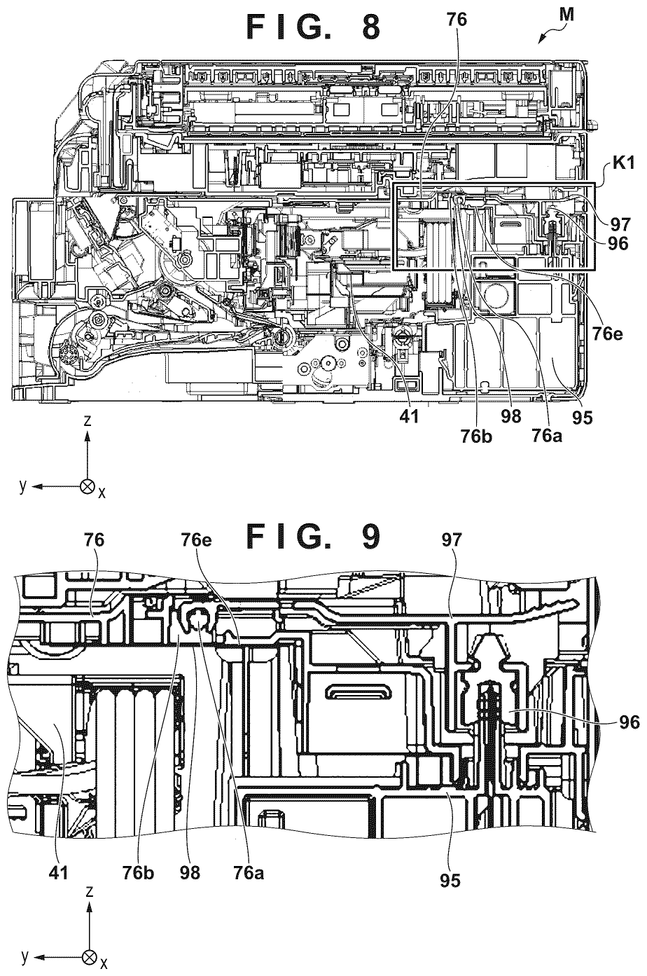

FIG. 8 is a side schematic diagram illustrating the internal structure of the printing apparatus M. FIG. 9 is an enlarged schematic diagram of a region K1 in FIG. 8. The printing apparatus M also includes a supply ink tank 95 that reserves ink to be supplied to the print head 42. Here, the supply ink tank 95 is installed on the front side/forward side of the carriage 41 equipped with the print head 42. The upper frame 76 elongates in the horizontal direction above the carriage 41 and the supply ink tank 95, to cover at least a part thereof.

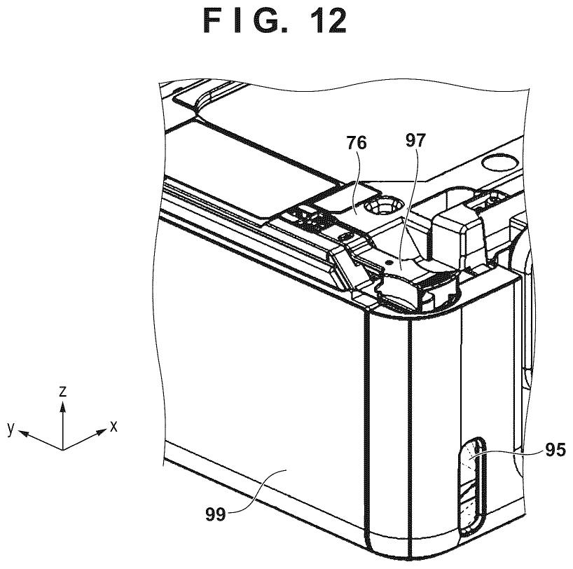

FIG. 12 is a perspective view of the region K1 regarding the printing apparatus M.

The upper frame 76 is swingably mounted with a lever 97. The distal end portion of the lever 97 is mounted with the supply ink tank plug 96, which brings a supply port of the supply ink tank 95 into a closed state. By operating lever 97, the user can bring the supply port of the supply ink tank 95 into an open state, for supplying the supply ink tank 95 with ink.

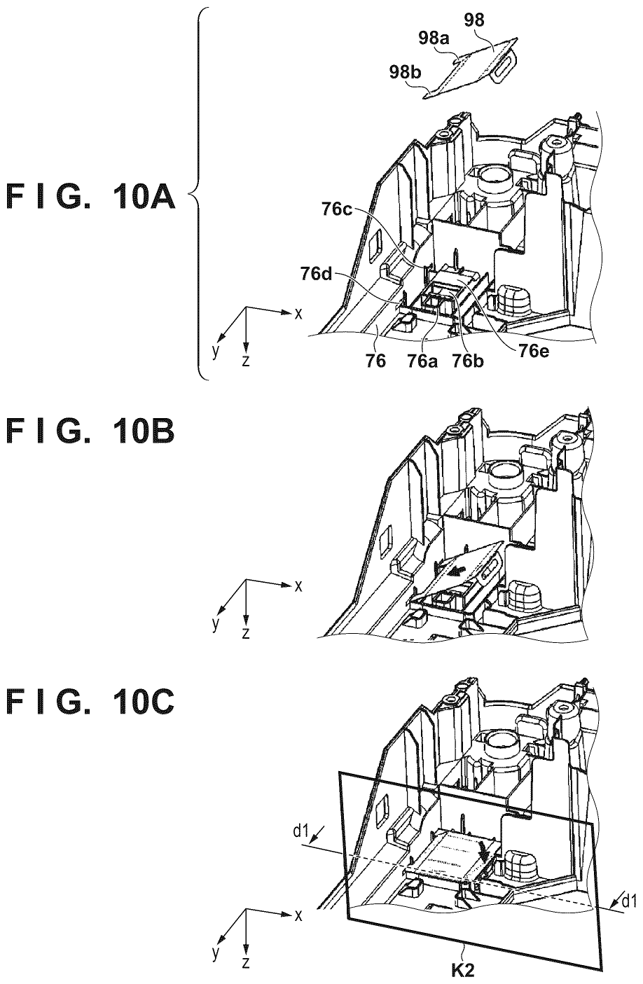

FIGS. 10A to 10C are perspective views illustrating the upper frame 76 as viewed from below, in the region K1. As illustrated in FIG. 10A, an opening hole portion 76b as a through hole can be formed in order to secure a region where, for example, the lever 97 can swing around the shaft portion 76a in the upper frame 76. A sheet member 98 is mounted so as to close a lower portion of this opening hole portion 76b.

FIG. 10A illustrates a state before the sheet member 98 is mounted. FIG. 10B illustrates a state during mounting of the sheet member 98. FIG. 10C illustrates a state after mounting the sheet member 98.

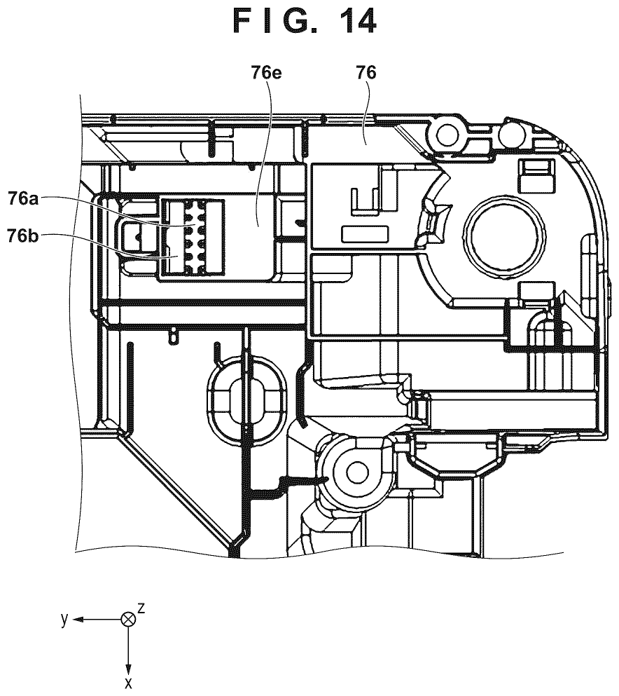

FIG. 14 is a schematic diagram illustrating only the upper frame 76 as viewed from below.

An end portion of the sheet member 98 includes a pair of protrusion portions 98a and 98b. A side surface of the upper frame 76 includes a pair of openings 76c and 76d. By overlapping the sheet member 98 on a sheet mounting surface 76e (FIG. 10A) of the upper frame 76 while inserting the protrusion portions 98a and 98b into the openings 76c and 76d, respectively, in a direction indicated by the arrow in FIG. 10B, a lower portion of the opening hole portion 76b can be closed with the sheet member 98.

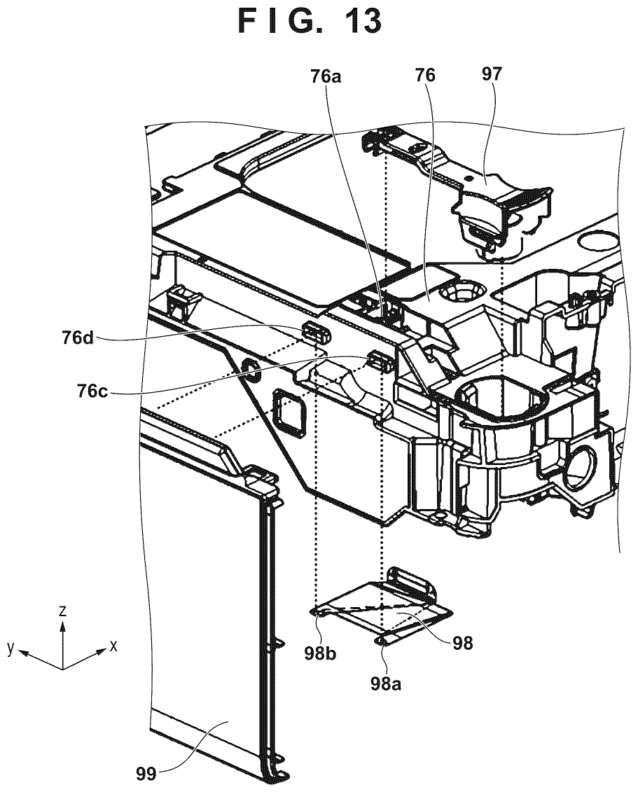

FIG. 13 is a perspective view illustrating a positional relationship between the upper frame 76 and the sheet member 98.

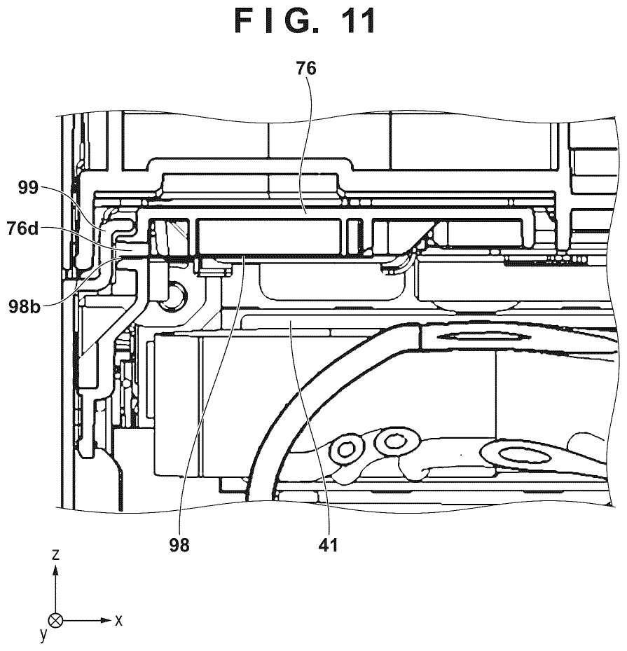

FIG. 11 is a cross-sectional view taken along line d1-d1 of a region K2 illustrated in FIG. 10C. The sheet member 98 can be mounted close to a side wall on a lower side of the opening 76d of the upper frame 76. The opening 76d is sealed by a side surface cover 99, which is a part of the exterior cover 110, at the outside thereof. The description of FIG. 11, which is referred to as a cross-sectional view passing through the opening 76d, also applies to a cross-sectional view passing through the opening 76c.

Accordingly, the opening hole portion 76b provided in the upper frame 76 for securing the region where the lever 97 can swing is closed by the sheet member 98. Thus, adhesion of foreign matters and the like to the lever 97 can be appropriately prevented. Together with this, the lever 97 may be provided in a swingable manner while maintaining the robustness of the upper frame 76, and the printing apparatus M may be implemented with high usability with a relatively simple configuration in addition to obtaining the same effects as those in the above-described embodiment.

### <<Others>>

The term “printing” mentioned herein should be broadly interpreted. Therefore, the aspect of “printing” includes an object formed on a print medium which may or may not be meaningful information such as characters or figures, and the object which may or may not be visualized for a person to visually perceive.

In addition, the term “print medium” should be broadly interpreted similarly to the aforementioned “printing”. Therefore, the concept of “print medium” can include any members that can receive ink, such as cloth, plastic films, metal plates, glass, ceramics, resin, wood, and leather, in addition to generally available paper.

In addition, the term “ink” should be broadly interpreted similarly to the aforementioned “printing”. The concept of “ink” therefore may include, in addition to liquid that is applied onto a print medium to form images, markings, patterns, and the like, auxiliary liquid that may be applied for processing of the print medium, or treatment of ink (e.g., solidification or insolubilization of colorant in the ink applied to the print medium).

For example, the printing apparatus M may be expressed as a liquid ejection apparatus or may be simply expressed as an ejection apparatus. For the same purpose, the print head 42 may be expressed as a liquid ejection head or may be simply expressed as an ejection head.

Individual components in the foregoing embodiments are named using expressions based on their main functions, the functions mentioned in the embodiments may be sub-functions and the nomenclature is not strictly limited to such expressions. The expression can be replaced with another similar expression. For the same purpose, the expression “unit” or “portion” can be replaced with “tool”, “component”, “member”, “structure”, “assembly”, or the like. Alternatively, those expressions may be omitted or attached.

In addition, two or more elements exemplarily described as selectable in the embodiment are not strictly limited to the description and may be combined. For example, each of the two or more elements exemplarily described as selectable may be additionally selected or alternatively selected. As an example, when two elements A and B are combined, the expression “A and/or B” or the expression “at least one of A and B” may be used to indicate any one of A only, B only, or both A and B.

While the present disclosure has been described with reference to certain exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-087247, filed May 29, 2024, which is incorporated herein by reference in its entirety.

What is claimed is:

1. A printing apparatus comprising:
a printing unit configured to perform printing on a sheet;
a lower frame constituting a part of a housing configured to accommodate the printing unit, the lower frame forming at least a part of a conveyance path of the sheet and including an engaged portion;
an upper frame constituting another part of the housing; and
a unit configured to mount on the lower frame and support the upper frame together with the lower frame, wherein
the unit includes a positioning portion for positioning with respect to the lower frame,
the positioning portion includes an engaging portion for engaging with the lower frame, and
when engaged with the lower frame, at least a portion of the positioning portion extends lower than the engaged portion . . .

2. The printing apparatus according to claim 1, wherein
the engaging portion elongates along a lower surface of the engaged portion of the lower frame.

3. The printing apparatus according to claim 1, wherein
the engaged portion includes a cutout portion configured to mount the unit from a lateral direction.

4. The printing apparatus according to claim 1, wherein
the positioning portion is configured to position the unit with respect to the lower frame and to fix the unit to the lower frame by fastening.

5. The printing apparatus according to claim 1, wherein
a wall portion is provided on an upper surface of the lower frame, in a lateral direction of the conveyance path, and
the unit is configured to mount from an opposite side to the conveyance path with respect to the wall portion.

6. The printing apparatus according to claim 1, wherein
the housing has a quadrangular shape in top view, and the unit is positioned at one corner of the housing.

7. The printing apparatus according to claim 1, wherein
the printing unit is configured to eject liquid, and
the unit is configured to accommodate a waste liquid reservoir.

8. The printing apparatus according to claim 7, wherein the waste liquid reservoir is replaceably accommodated in an accommodating portion and is configured to accommodate waste liquid.

9. The printing apparatus according to claim 1, wherein
the lower frame is integrally molded with resin.

10. The printing apparatus according to claim 1 further comprising:
an exterior cover, wherein
the lower frame and the upper frame are joined to each other with the unit mounted between the lower frame and the upper frame, and
the exterior cover covers the lower frame and the upper frame joined to each other, with an opening to expose the positioning portion.

11. The printing apparatus according to claim 1 further comprising:
an image reading unit axially supported on the upper frame in a rotatable manner; and
a support column supporting the upper frame below a part axially supporting the image reading unit in the upper frame, the support column being independent of the lower frame.

12. The printing apparatus according to claim 1, wherein
the upper frame is provided with an opening hole portion, and a sheet member is configured to close a lower part of the opening hole portion.

13. The printing apparatus according to claim 12, wherein
the opening hole portion is a through hole configured to surround a shaft portion of the upper frame.

14. The printing apparatus according to claim 12, wherein
an end portion of the sheet member includes a protrusion portion, and a side surface of the upper frame includes an opening for insertion of the protrusion portion of the sheet member therein, and
the opening is sealed by an exterior cover.
